(19) United States
(12) Patent Application Publication
(10) Pub. No.: US 2013/0189563 A1
(43) Pub. Date: Jul. 25, 2013

(54) BATTERY MODULE AND A METHOD FOR ASSEMBLING BATTERY MODULES

(71) Applicants: Tae Young Chang, Seoul (KR); Gyu Wan Choi, Incheon (KR)

(72) Inventors: Tae Young Chang, Seoul (KR); Gyu Wan Choi, Incheon (KR)

(21) Appl. No.: 13/638,907

(22) PCT Filed: Mar. 3, 2011
(86) PCT No.: PCT/KR2011/001456

§ 371 Date: Feb. 14, 2013

(30) Foreign Application Priority Data
Apr. 6, 2010 (KR) 10-2010-0031490

(51) Int. Cl. H01M 2/10; B23P 11/00

(52) U.S. Cl. CPC H01M 2/1077; B23P 11/00
USPC 429/160; 29/428

(57) ABSTRACT

Provided are: a battery module which not only facilitates the work of serial and/or parallel coupling a plurality of stacked cell cartridges but also improves safety for workers during the coupling work; and a method for assembling battery modules.

### TECHNICAL FIELD

The present invention relates to a battery module and an assembly method of the same, and more particularly to a battery module and an assembly method of the same in which a plurality of stacked cell cartridges is easily connected to each other in series and/or in parallel, and safety of workers is improved during connection of the cell cartridges.

### BACKGROUND ART

One of the biggest problems caused by vehicles using fossil fuel, such as gasoline and diesel, is the creation of air pollution. A technology of using a secondary battery, which can be charged and discharged, as a power source for vehicles has attracted considerable attention as one method of solving such a problem. As a result, electric vehicles (EV), which are operated using only a battery, and hybrid electric vehicles (HEV), which cooperatively use a battery and a conventional engine, have been developed. Some electric vehicles and hybrid electric vehicles are now being commercially used. A nickel metal hydride (Ni-MH) secondary battery has mainly been used as the power source electric vehicles (EV) and hybrid electric vehicles (HEV). In recent years, however, the use of a lithium ion battery has been attempted.

High power and capacity are needed for such a secondary battery to be used as the power source for electric vehicles (EV) and hybrid electric vehicles (HEV).

To this end, a plurality of small-sized secondary batteries (unit cells) is connected to each other in series and/or in parallel so as to constitute a middle or large-sized battery module.

A prismatic battery or a pouch-shaped battery, which can be stacked with high density to reduce the size of a dead space, is usually used as each of the unit cells constituting the middle or large-sized battery module. A cell cartridge, in which one or more unit cells are mounted, is generally used to easily achieve mechanical coupling and electrical connection between the unit cells. That is, a plurality of cell cartridges, in each of which unit cells are mounted, is connected to each other in series and/or in parallel to constitute a battery module.

### DISCLOSURE

### Technical Problem

It is an object of the present invention to provide a battery module and an assembly method of the same in which a plurality of stacked cell cartridges is easily connected to each other in series and/or in parallel, and safety of workers is improved during connection of the cell cartridges.

Objects of the present invention are not limited by the above object, and those skilled in the art to which the present invention pertains will clearly understand other unmentioned objects from the following description.

### Technical Solution

In order to accomplish the above object, a battery module according to an embodiment of the present invention includes a plurality of stacked cell cartridges to generate current, bus bars to electrically interconnect the stacked cell cartridges, a bus bar plate having bus bar receiving grooves, in which the bus bars are received, and a plate cover coupled to the bus bar plate to cover the bus bars received in the bus bar receiving grooves.

Also, an assembly method of a battery module according to an embodiment of the present invention includes stacking a plurality of cell cartridges to generate current, receiving bus bars to electrically interconnect the stacked cell cartridges in bus bar receiving grooves formed at a bus bar plate, covering the bus bars received in the bus bar receiving grooves with a plate cover, and inserting positive electrode terminals and negative electrode terminals formed at the cell cartridges into the bus bar plate or the plate cover so that the positive electrode terminals and the negative electrode terminals are connected to the bus bars.

Also, an assembly method of a battery module according to another embodiment of the present invention includes stacking a plurality of cell cartridges to generate current, receiving bus bars to electrically interconnect the cell cartridges stacked in the same row in bus bar receiving grooves formed at a bus bar plate and receiving a jump bar to electrically interconnect the cell cartridges stacked in different rows in a jump bar receiving groove formed at the bus bar plate, covering the bus bars received in the bus bar receiving grooves and the jump bar received in the jump bar receiving groove with a plate cover, and inserting positive electrode terminals and negative electrode terminals formed at the cell cartridges into the bus bar plate or the plate cover so that the positive electrode terminals and the negative electrode terminals are connected to the bus bars and the jump bar.

Details of other embodiments are included in the detailed description of the invention and the accompanying drawings.

### Advantageous Effects

In a battery module and an assembly method of the same according to the present invention, bus bars and a jump bar to interconnect a plurality of cell cartridges in series and/or in parallel are received in bus bar receiving grooves and a jump bar receiving groove formed at a bus bar plate so that the bus bars and the jump bar form a connection module together with the bus bar plate and a plate cover, and the cell cartridges are interconnected in series and/or in parallel via the connection module, thereby easily achieving electrical connection between the cell cartridges.

Also, the bus bars and the jump bar are disposed in the bus bar plate and the plate cover, which are formed of insulators. When connection work is performed, therefore, it is possible to protect workers from electrical shock, thereby improving safety.

The effects of the present invention are not limited to the above-mentioned effects, and it will be apparent to those skilled in the art to which the present invention pertains that other unmentioned effects will be understood from the appended claims.

### DESCRIPTION OF DRAWINGS

FIG. 1 is an exploded perspective view showing a battery module according to an embodiment of the present invention;

FIG. 2 is an exploded perspective view of a cell cartridge shown in FIG. 1;

FIGS. 3 to 6 are views showing a unit cell of a cell cartridge according to an embodiment of the present invention;

FIG. 7 is a view showing a portion of the cell cartridge according to the embodiment of the present invention;

FIG. 8 is a view showing a portion of the cell cartridge according to the embodiment of the present invention;

FIG. 9 is a view showing that cell cartridges according to an embodiment of the present invention are stacked;

FIG. 10 is a front view showing a bus bar plate according to an embodiment of the present invention;

FIG. 11 is a flow chart showing an assembly method of a battery module according to an embodiment of the present invention;

FIG. 12 is a flow chart showing an assembly method of a battery module according to another embodiment of the present invention;

FIG. 13 is a view showing that cell cartridges according to another embodiment of the present invention are stacked; and

FIG. 14 is a front view showing a bus bar plate according to another embodiment of the present invention.

### BEST MODE

Advantages and features of the present invention and a method of achieving the advantages and features of the present invention will be clearly understood from embodiments described hereinafter in conjunction with the accompanying drawings. However, the present invention is not limited to the following embodiments and may be realized in various different forms. These embodiments are provided only to completely disclose the present invention and for a person having ordinary skill in the art to which the present invention pertains to completely understand the category of the invention. That is, the present invention is defined only by the category of the claims. The same reference numbers will be used throughout this specification to refer to the same parts.

Hereinafter, preferred embodiments of the present invention will be described in detail with reference to the accompanying drawings illustrating a battery module.

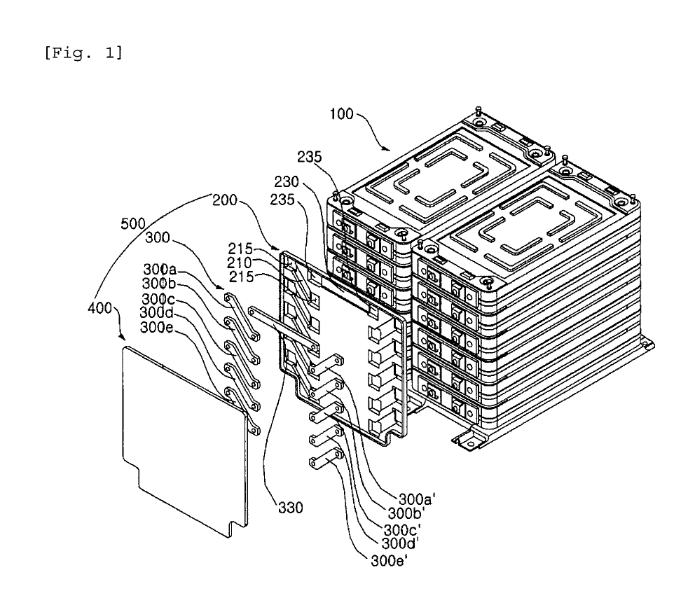

FIG. 1 is an exploded perspective view showing a battery module according to an embodiment of the present invention.

Referring to FIG. 1, the battery module according to the embodiment of the present invention includes a plurality of stacked cell cartridges 100, bus bars 300 to electrically interconnect the stacked cell cartridges 100, a bus bar plate 200 having bus bar receiving grooves 210, in which the bus bars 300 are received, and a plate cover 400 coupled to the bus bar plate 200 to cover the bus bars 300 received in the bus bar receiving grooves 210.

The bus bars 300 are formed of conductors to electrically interconnect the cell cartridges 100, and the bus bar plate 200 and the plate cover 400 are formed of insulators to cover outsides of the bus bars 300.

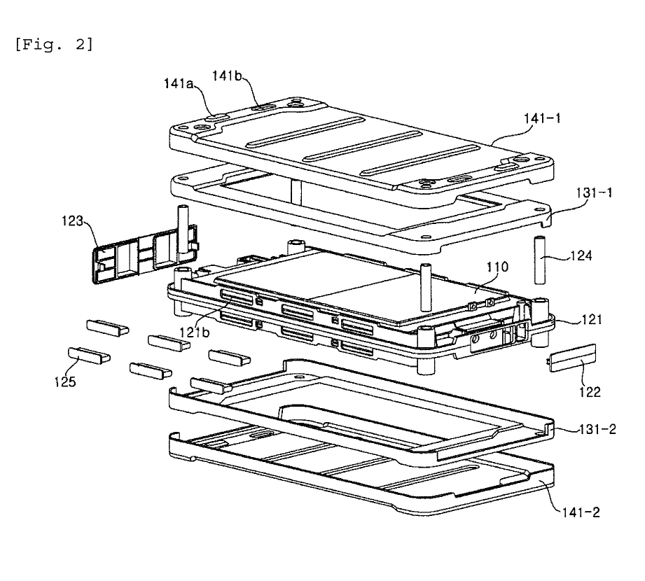

FIG. 2 is an exploded perspective view of one of the cell cartridges 100 shown in FIG. 1.

Referring to FIG. 2, a cell cartridge 100 according to an embodiment of the present invention includes a plurality of unit cells 110, an upper side cartridge inner 131-1, a lower side cartridge inner 131-2, a cartridge center 121, an upper side cover 141-1, and a lower side cover 141-2.

Each of the unit cells 110 is a nickel metal hydride (Ni-MH) cell or a lithium ion (Li-ion) cell to generate current. The unit cells 110 are mounted in the cartridge center 121. The upper side cartridge inner 131-1 is disposed in tight contact with the edge of the top of the unit cells 110, and the upper side cover 141-1 is disposed in tight contact with the middle portion of the top of the unit cells 110. The lower side cartridge inner 131-2 is disposed in tight contact with the edge of the bottom of the unit cells 110, and the lower side cover 141-2 is disposed in tight contact with the middle portion of the bottom of the unit cells 110.

The upper side cover 141-1 is disposed in contact with the top of the unit cells 110 to dissipate heat from the unit cells 110. The upper side cover 141-1 is preferably formed of an aluminum material exhibiting high heat dissipation. The upper side cartridge inner 131-1 is disposed between the upper side cover 141-1 and the unit cells 110.

The upper side cartridge inner 131-1 is disposed in contact with the edge of the top of the unit cells 110. The upper side cartridge inner 131-1 insulates the edge of the top of the unit cells 110 from the upper side cover 141-1 to prevent direct contact between the edge of the top of the unit cells 110 and the upper side cover 141-1. The upper side cartridge inner 131-1 supports the edge of the top of the unit cells 110 and the upper side cover 141-1 between the edge of the top of the unit cells 110 and the upper side cover 141-1 to protect the edge of the top of the unit cells 110.

The lower side cover 141-2 and the lower side cartridge inner 131-2 are configured in the same manner as in the above description, and therefore, a detailed description thereof will be omitted.

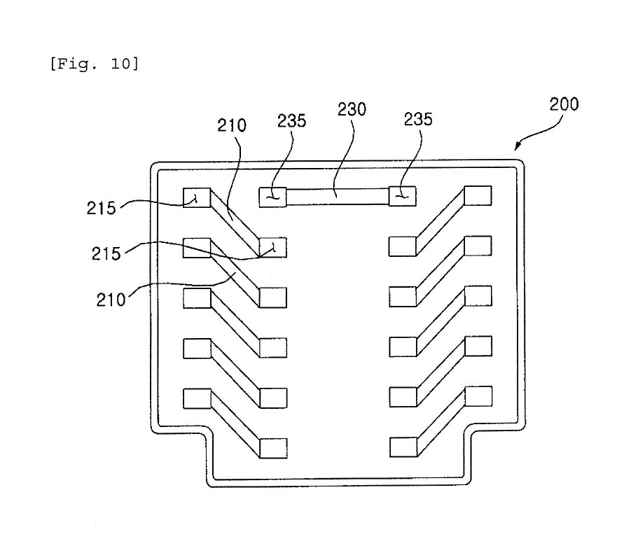

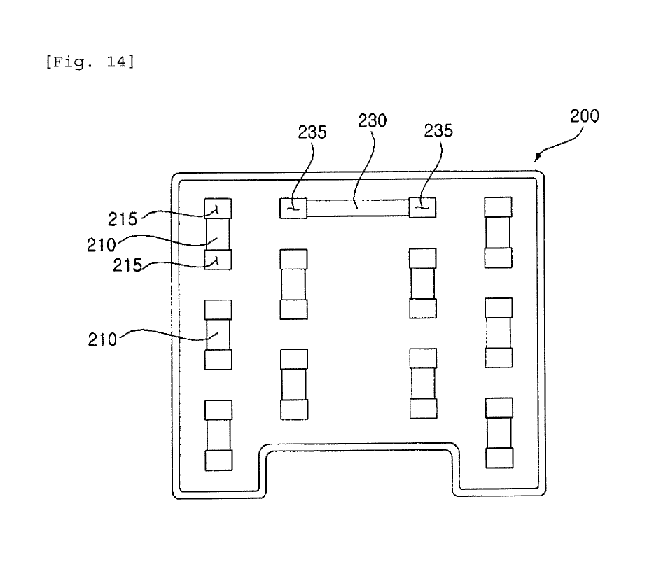

Convex parts 141a and concave parts 141b are formed at the upper side cover 141-1 and the lower side cover 141-2. The convex parts 141a and the concave parts 141b are coupled to each other, when cell cartridges are stacked, to dispose the cell cartridges in place. The convex parts 141a and the concave parts 141b are formed at four corners of the top of the upper side cover 141-1 in a symmetrical fashion to enable forward direction stacking in which the cell cartridges are stacked in the forward direction and reverse direction stacking in which the cell cartridges are stacked in the reverse direction, which will be described below with reference to FIGS. 9 and 13.

The unit cells 110 are mounted in the cartridge center 121. The upper side cover 141-1 is coupled to the upper side of the cartridge center 121 via the upper side cartridge inner 131-1. The lower side cover 141-2 is coupled to the lower side of the cartridge center 121 via the lower side cartridge inner 131-2. The coupling may be achieved by bonding, bolting, welding, etc.

The cartridge center 121 is provided with spacers 124 to support the upper side cartridge inner 131-1, the upper side cover 141-1, the lower side cartridge inner 131-2, and the lower side cover 141-2. When the cell cartridges are stacked, long bolts are inserted through the spacers 124 to couple the cell cartridges to each other.

Cartridge supports 125 are fitted in side holes 121b formed at the cartridge center 121. The cartridge supports 125 support the edge of the unit cells 110 to protect the unit cells 110.

A cover front 123 is coupled to the front of the cartridge center 121, and a cover rear 122 is coupled to the rear of the cartridge center 121, to protect terminals of the unit cells 110.

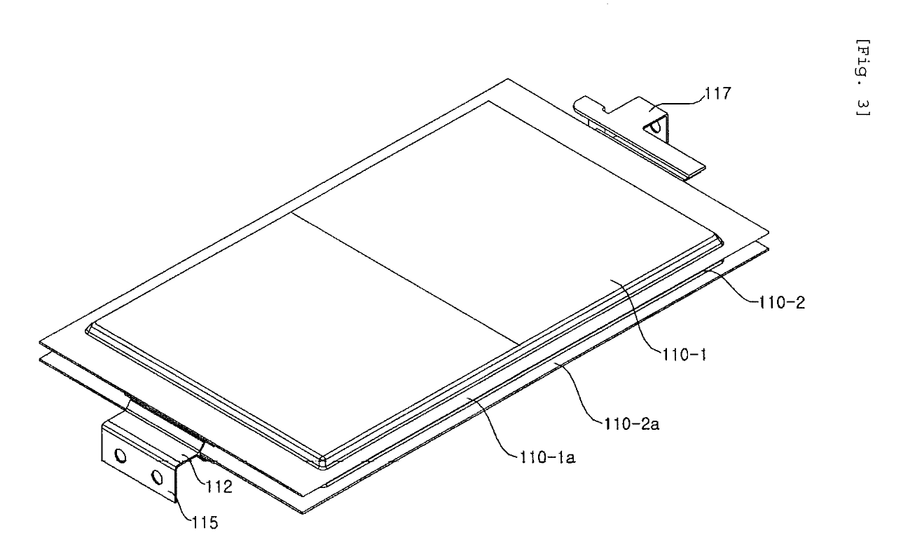

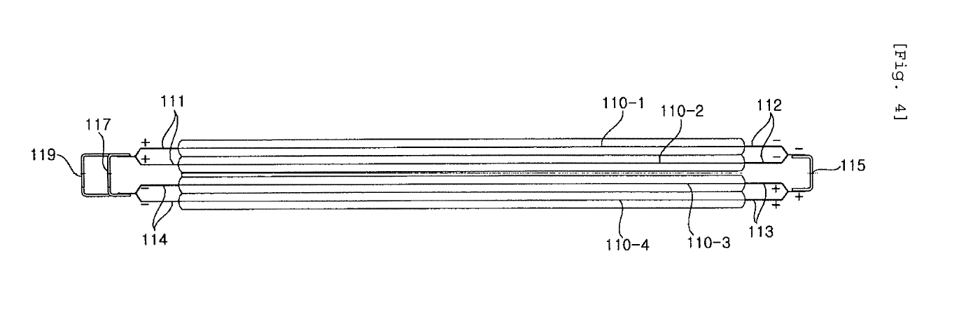

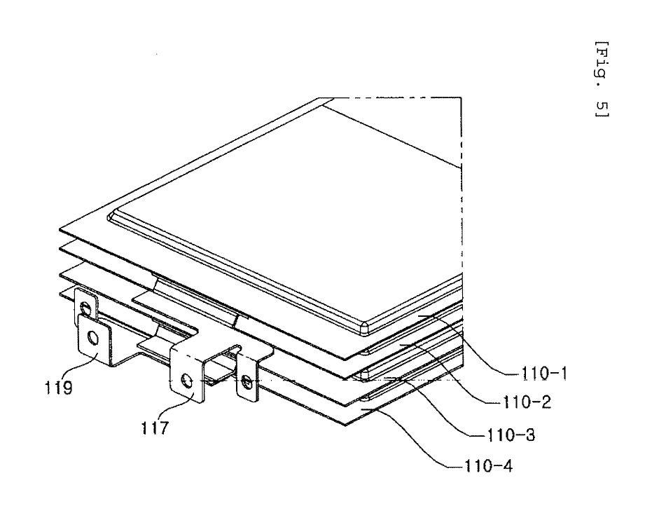

FIGS. 3 to 6 are views showing a unit cell of a cell cartridge according to an embodiment of the present invention.

The unit cells 110 preferably include four unit cells 110, i.e. a first unit cell 110-1 to a fourth unit cell 110-4. However, the number of the unit cells may be changed depending upon the shape of each of the unit cells 110.

The first unit cell 110-1 and the second unit cell 110-2 are coupled to each other in a tight contact fashion, and the third unit cell 110-3 and the fourth unit cell 110-4 are coupled to each other in a tight contact fashion. A gap is formed between the second unit cell 110-2 and the third unit cell 110-3. The gap between the second unit cell 110-2 and the third unit cell 110-3 is formed by the cartridge center 121. The gap between the second unit cell 110-2 and the third unit cell 110-3 is provided to allow swelling of the unit cells during charging and discharging of the unit cells. A heat sensor may be disposed in the gap between the second unit cell 110-2 and the third unit cell 110-3.

A first unit cell sealing part 110-1a is a portion to seal the edge of the first unit cell 110-1. If the first unit cell sealing part 110-1a is torn or broken, electrical conduction may occur due to leakage of liquid. Consequently, the first unit cell sealing part 110-1a is disposed in tight contact with the upper side cartridge inner 131-1 so that the first unit cell sealing part 110-1a can be insulated and protected.

The cartridge supports 125 are disposed between the first unit cell sealing part 110-1a and a second unit cell sealing part 110-2a to support, protect, and insulate the respective sealing parts. In particular, the cartridge supports 125 prevent the occurrence of electrical conduction due to leakage of liquid caused by damage to, such as partial tear or breakage of, the first unit cell sealing part 110-1a and the second unit cell sealing part 110-2a, coming into contact with the upper side cartridge inner 131-1 due to drooping of the first unit cell sealing part 110-1a and the second unit cell sealing part 110-2a by gravity in a state in which the cell cartridge is erected vertically, due to vibration of a vehicle.

The first unit cell 110-1 and the second unit cell 110-2 are connected to each other in parallel, and the third unit cell 110-3 and the fourth unit cell 110-4 are connected to each other in parallel. The two sets of unit cells are connected to each other in series. Consequently, the unit cells 110 are connected to have a two parallel and two series structure. However, the connection structure of the unit cells may be changed depending upon required voltage and capacity.

When looking into the unit cells, an anode (+) and a cathode (−) are formed at each of the unit cells 110. The anode (+) of the first unit cell 110-1 and the anode (+) of the second unit cell 110-2 are connected to each other in parallel via a first parallel connection member 111, and the cathode (−) of the first unit cell 110-1 and the cathode (−) of the second unit cell 110-2 are connected to each other in parallel via a second parallel connection member 112.

Also, the anode (+) of the third unit cell 110-3 and the anode (+) of the fourth unit cell 110-4 are connected to each other in parallel via a third parallel connection member 113, and the cathode (−) of the third unit cell 110-3 and the cathode (−) of the fourth unit cell 110-4 are connected to each other in parallel via a fourth parallel connection member 114.

Subsequently, the second parallel connection member 112 and the third parallel connection member 113 are connected to each other in series via a serial connection member 115, a positive electrode terminal 117 is connected to the first parallel connection member, and a negative electrode terminal 119 is connected to the fourth parallel connection member 114. As a result, the unit cells 110 are connected to have a two parallel and two series structure.

The positive electrode terminal 117 interconnects the first unit cell 110-1 and the second unit cell 110-2 in parallel to form an anode of the unit cells 110. The positive electrode terminal 117 is disposed at one side of the unit cells 110. The negative electrode terminal 119 interconnects the third unit cell 110-3 and the fourth unit cell 110-4 in parallel to form a cathode of the unit cells 110. The negative electrode terminal 119 is disposed at one side of the unit cells 110 in parallel with the positive electrode terminal 117.

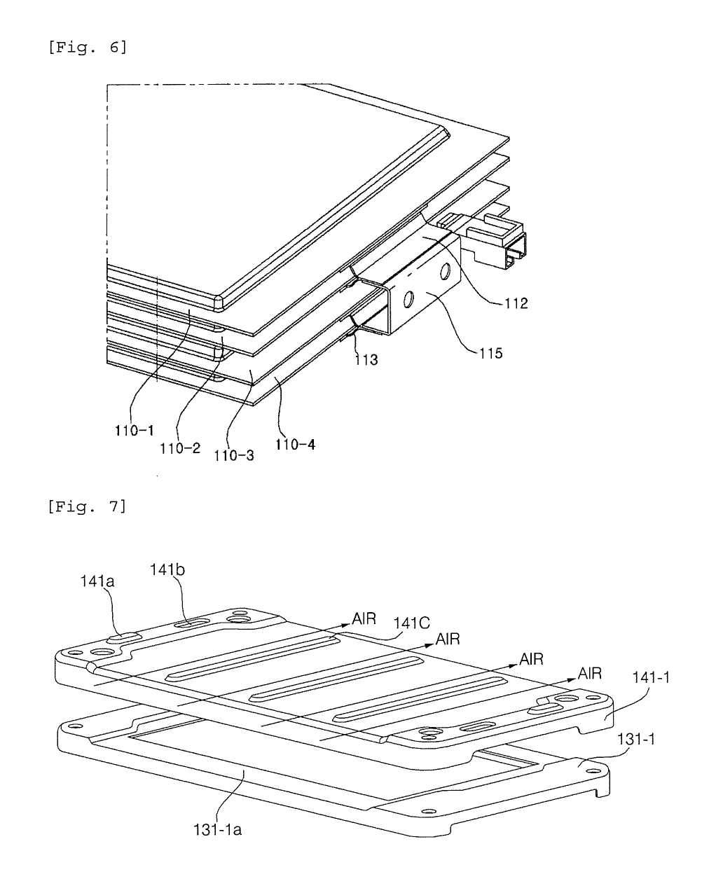

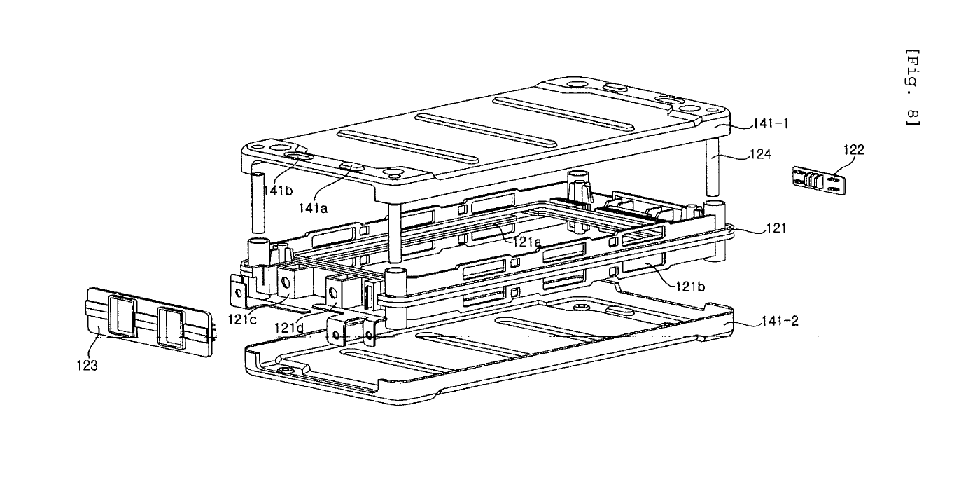

FIG. 7 is a view showing a portion of the cell cartridge according to the embodiment of the present invention.

Ventilation protrusions 141c are formed at the top of the upper side cover 141-1. In a case in which cell cartridges 100 are stacked and cooled in an air cooling fashion, air flows between the respective ventilation protrusions 141c to dissipate heat from the upper side cover 141-1. The ventilation protrusions 141c may be formed at the top of the upper side cover 141-1 in the lateral direction or in the longitudinal direction based on the flow of air. Also, in a case in which the cell cartridges 100 are stacked, the ventilation protrusions 141c serve to maintain a gap between neighboring cell cartridges 100, which is provided to allow swelling of the unit cells 110 during charge and discharge of the unit cells 110.

Ventilation protrusions 141c are also formed at the lower side cover 141-2.

The upper side cartridge inner 131-1 has a tight contact plane 131-1a disposed in tight contact with the first unit cell sealing part 110-1a.

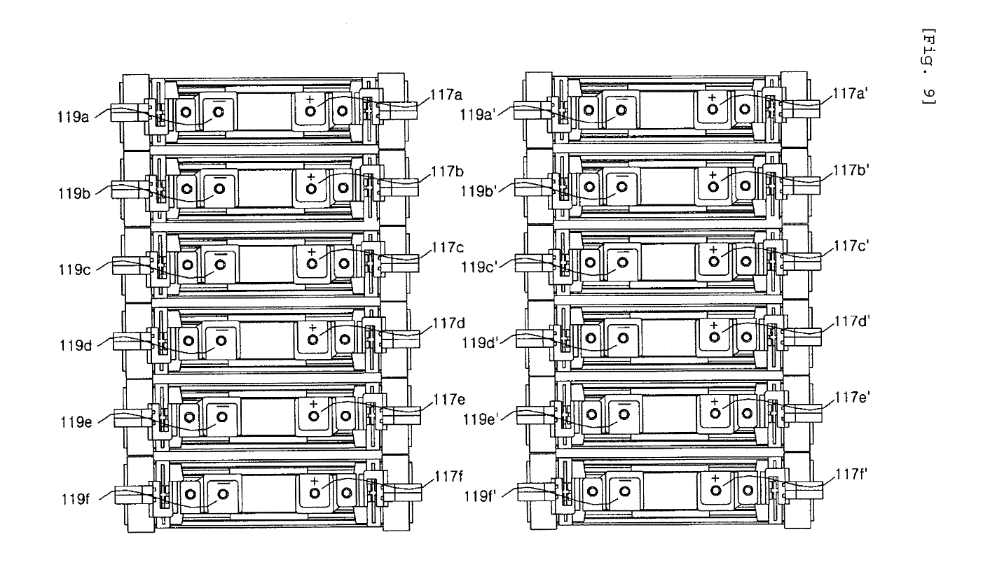

FIG. 8 is a view showing a portion of the cell cartridge according to the embodiment of the present invention. The cartridge center 121 has a center gap 121 defined between the second unit cell 110-2 and the third unit cell 110-3 when the second unit cell 110-2 and the third unit cell 110-3 are coupled to each other. The cartridge center 121 is provided at the front thereof with a positive electrode 121c, at which the positive electrode terminal 117 is located, and a negative electrode 121d, at which the negative electrode terminal 119 is located.

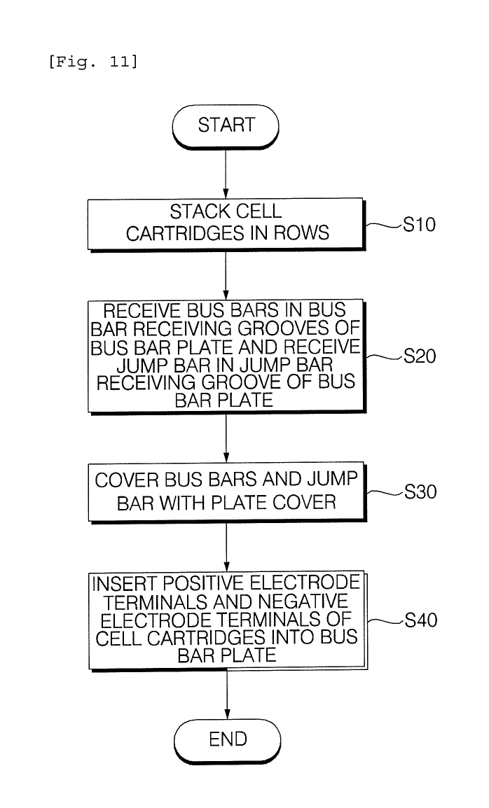

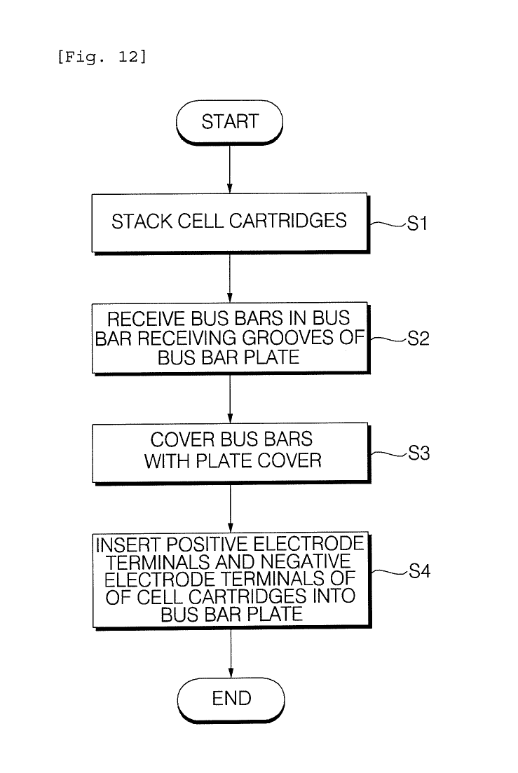

FIG. 9 is a view showing that cell cartridges according to an embodiment of the present invention are stacked, FIG. 10 is a front view showing a bus bar plate according to an embodiment of the present invention, and FIG. 11 is a flow chart showing an assembly method of a battery module according to an embodiment of the present invention. Hereinafter, a battery module according to an embodiment of the present invention and an assembly method of a battery module according to an embodiment of the present invention will be described considering the assembly method of the battery module in connection with the battery module.

Referring to FIGS. 1 and 9 to 11, in the battery module according to the embodiment of the present invention, a plurality of cell cartridges 110 is stacked to form a plurality of rows (S10). In FIG. 9, the cell cartridges 110 are arranged to form two rows, in each of which six cell cartridges 110 are stacked.

In the left row, the cell cartridges 110 are stacked in the same direction so that negative electrode terminals 119a to 119f and positive electrode terminals 117a to 117f are disposed in a line. Also, in the right row, the cell cartridges 110 are stacked in the same direction so that negative electrode terminals 119a′ to 119f′ and positive electrode terminals 117a′ to 117f′ are disposed in a line.

The bus bar receiving grooves 210 are obliquely formed at the bus bar plate 200 so that the bus bars 300 can interconnect the negative electrode terminals 119a to 119f and 119a′ to 119f′ and the positive electrode terminals 117a to 117f and 117a′ to 117f′, arranged in a line in each row, in series. Here, the negative electrode terminals 119a to 119f and 119a′ to 119f′ and the positive electrode terminals 117a to 117f and 117a′ to 117f′ may be connected to one another in parallel via the bus bars 300. Alternatively, the negative electrode terminals 119a to 119f and 119a′ to 119f′ and the positive electrode terminals 117a to 117f and 117a′ to 117f′ may be connected to one another in series and in parallel. In the following description, the cell cartridges 100 are connected to one another in series to output high power current.

Also, the battery module according to the embodiment of the present invention further includes a jump bar 330 to interconnect the stacked cell cartridges 100 of one row and the stacked cell cartridges 100 of the other row in series.

Consequently, a jump bar receiving groove 230, in which the jump bar 330 is received, is formed at the bus bar plate 200.

In this embodiment, the cell cartridges 110 are arranged to form two rows, in each of which six cell cartridges 110 are stacked. Consequently, a total of ten bus bar receiving grooves 210, including five in each row, are formed at the bus bar plate 200, and ten bus bars 300 are provided. Also, one jump bar receiving groove 230 is formed, and one jump bar 330 is provided.

Six cell cartridges 100 are stacked in each row so that the rows have the same height, and the jump bar 330 interconnects neighboring cell cartridges 100. Consequently, the jump bar receiving groove 230 is horizontally formed. On the other hand, if different numbers of cell cartridges 100 are stacked in the respective row so that the rows have different heights, the jump bar receiving groove 230 may be obliquely in the same manner as the bus bar receiving grooves 210.

At opposite ends of the bus bar receiving grooves 210 of the bus bar plate 200 are formed terminal insertion holes 215, into which the negative electrode terminals 119a to 119f and 119a′ to 119f′ and the positive electrode terminals 117a to 117f and 117a′ to 117f′ are inserted. Also, terminal insertion holes 235 are formed at opposite ends of the jump bar receiving groove 230. When the negative electrode terminals 119a to 119f and 119a′ to 119f′ and the positive electrode terminals 117a to 117f and 117a′ to 117f′ are inserted into the terminal insertion holes 215 and 235 formed at the bus bar plate 200 in a state in which the bus bars 300 are received in the bus bar receiving grooves 210, and the jump bar 330 is received in the jump bar receiving groove 230, the negative electrode terminals 119a to 119f and 119a′ to 119f′ and the positive electrode terminals 117a to 117f and 117a′ to 117f′ are automatically connected to the bus bars 300 received in the bus bar receiving grooves 210 and to the jump bar 330 received in the jump bar receiving groove 230. As a result, the cell cartridges 100 are connected to one another in series.

That is, the first negative electrode terminal 119a is connected to the second positive electrode terminal 117b, which is diagonally opposite to the first negative electrode terminal 119a, via a first bus bar 300a, and the second negative electrode terminal 119b is connected to the third positive electrode terminal 117c, which is diagonally opposite to the second negative electrode terminal 119b, via a second bus bar 300b. In the same manner, the third negative electrode terminal 119c is connected to the fourth positive electrode terminal 117d, which is diagonally opposite to the third negative electrode terminal 119c, via a third bus bar 300c, the fourth negative electrode terminal 119d is connected to the fifth positive electrode terminal 117e, which is diagonally opposite to the fourth negative electrode terminal 119d, via a fourth bus bar 300d, and the fifth negative electrode terminal 119e is connected to the sixth positive electrode terminal 117f, which is diagonally opposite to the fifth negative electrode terminal 119e, via a fifth bus bar 300e.

Also, the negative electrode terminals 119a′ to 119f′ and the positive electrode terminals 117a′ to 117f′ of the six stacked cell cartridges 100 in the neighboring row are connected to one another in series in the same manner. Specifically, the first positive electrode terminal 117a′ is connected to the second negative electrode terminal 119b′, which is diagonally opposite to the first positive electrode terminal 117a′, via a first bus bar 300a′, and the second positive electrode terminal 117b′ is connected to the third negative electrode terminal 119c′, which is diagonally opposite to the second positive electrode terminal 117b′, via a second bus bar 300b′. In the same manner, the third positive electrode terminal 117c′ is connected to the fourth negative electrode terminal 119d′, which is diagonally opposite to the third positive electrode terminal 117c′, via a third bus bar 300c′, the fourth positive electrode terminal 117d′ is connected to the fifth negative electrode terminal 119e′, which is diagonally opposite to the fourth positive electrode terminal 117d′, via a fourth bus bar 300d′, and the fifth positive electrode terminal 117e′ is connected to the sixth negative electrode terminal 119f′, which is diagonally opposite to the fifth positive electrode terminal 117e′, via a fifth bus bar 300e′.

Also, the jump bar 330 interconnects the first positive electrode terminal 117a and the negative electrode terminal 119a′ of the cell cartridge 100 disposed in the row neighboring to the first positive electrode terminal 117a in series. As a result, a total of 12 cell cartridges 100 are connected to one another in series. The 12 cell cartridges 100 connected to one another in series constitute a battery module, which may output current through the sixth negative electrode terminal 119f and the sixth positive electrode terminal 117f′ disposed in the row neighboring to the sixth negative electrode terminal 119f. Alternatively, the battery module may be connected to another battery module in series through the sixth negative electrode terminal 119f and the sixth positive electrode terminal 117f′ of the cell cartridge 100 disposed in the row neighboring to the sixth negative electrode terminal 119f to output higher power current.

In order to interconnect the cell cartridges 100 stacked in the plurality of rows as described above, the bus bars 300 are received in the respective bus bar receiving grooves 210 formed at the bus bar plate 200, and the jump bar 330 is received in the jump bar receiving groove 230 formed at the bus bar plate 200 (S20). Here, the bus bars 300 are provided to electrically interconnect the cell cartridges 110 stacked in the same row, and the jump bar 330 is provided to electrically connect the cell cartridges 110 stacked in one row to the cell cartridges 110 stacked in the other row.

After the bus bars 300 are received in the respective bus bar receiving grooves 210, and the jump bar 330 is received in the jump bar receiving groove 230 as described above, the plate cover 300 is coupled to the bus bar plate 200 so cover the bus bars 300 and the jump bar 330 so that the bus bars 300 and the jump bar 330 cannot be exposed to the outside.

The bus bars 300, the jump bar 330, the bus bar plate 200, and the plate cover 400 are coupled as described above to form a connection module 500.

After the connection module 500 is formed, the negative electrode terminals 119a to 119f and 119a′ to 119f′ and the positive electrode terminals 117a to 117f and 117a′ to 117f′ are inserted into the terminal insertion holes 215 and 235 of the bus bar plate 200. As a result, the negative electrode terminals 119a to 119f and 119a′ to 119f′ and the positive electrode terminals 117a to 117f and 117a′ to 117f′ are automatically connected to the bus bars 300 and the jump bar 330, and therefore, the cell cartridges 100 stacked in the plurality of rows are interconnected in series (S40).

After the negative electrode terminals 119a to 119f and 119a′ to 119f′ and the positive electrode terminals 117a to 117f and 117a′ to 117f′ are inserted into the connection module 500 so that the negative electrode terminals 119a to 119f and 119a′ to 119f′ and the positive electrode terminals 117a to 117f and 117a′ to 117f′ are interconnected in series via the bus bars 300 and the jump bar 330 as described above, the connection module 500 may be coupled to the stacked cell cartridges 100 by bonding, bolting, welding, etc.

Meanwhile, in the above description, the bus bar receiving grooves 210, the jump bar receiving groove 230, and the terminal insertion holes 215 and 235 are all formed at the bus bar plate 200. Alternatively, the bus bar receiving grooves 210, the jump bar receiving groove 230, and the terminal insertion holes 215 and 235 may be formed at the bus bar plate 200 or the plate cover 400.

For example, the bus bar receiving grooves 210 and the jump bar receiving groove 230 may be formed at the bus bar plate 200, and the terminal insertion holes 215 and 235 may be formed at the plate cover 400. In this case, the negative electrode terminals 119a to 119f and 119a′ to 119f′ and the positive electrode terminals 117a to 117f and 117a′ to 117f′ of the cell cartridges 100 may be inserted into the terminal insertion holes 215 and 235 formed at the plate cover 400, and then the bus bars 300 received in the bus bar receiving grooves 210 of the bus bar plate 200 may be connected to the jump bar 330 received in the jump bar receiving groove 230 of the bus bar plate 200. As a result, the negative electrode terminals 119a to 119f and 119a′ to 119f′ and the positive electrode terminals 117a to 117f and 117a′ to 117f′ may be interconnected in series.

In the battery module according to the embodiment of the present invention as described above, after the connection module 300 is completed, the negative electrode terminals 119a to 119f and 119a′ to 119f′ and the positive electrode terminals 117a to 117f and 117a′ to 117f′ are inserted into the connection module 500 with the result that the negative electrode terminals 119a to 119f and 119a′ to 119f′ and the positive electrode terminals 117a to 117f and 117a′ to 117f′ are automatically connected to the bus bars 300 and the jump bar 330, thereby improving workability.

Also, the bus bar plate 200 and the plate cover 400, in which the bus bars 300 and the jump bar 330 formed of conductors are received, are formed of insulators. When work for electrically interconnecting the cell cartridges 100 is performed, therefore, it is possible to protect workers from electrical shock. In this embodiment, the bus bar plate 200 and the plate cover 400 are formed of plastic.

In the above description, the cell cartridges 100 are stacked in the plurality of rows (two rows), and therefore, the bus bar receiving grooves 210 are formed at the bus bar plate 200 in the plurality of rows (two rows), and the jump bar 230 is formed at the bus bar plate 200. On the other hand, in a case in which the cell cartridges 100 are stacked in a single row, the bus bar receiving grooves 210 may be formed at the bus bar plate 200 in a single row, and the jump bar 230 may not be formed at the bus bar plate 200.

A case in which the cell cartridges 100 are stacked in a single row will hereinafter be described as an example. If the cell cartridges 100 are stacked only in the left row in FIG. 1, the bus bar receiving grooves 210 may be formed at a portion of the bus bar plate 200 corresponding to the left row. In this case, only the bus bars 300a to 300e are necessary as the bus bars 300, and the jump bar 330 is not necessary. Consequently, the bus bars 300a to 300e are received in the bus bar receiving grooves 210 formed at the bus bar plate 200, and the plate cover 400 covers the bus bars 300a to 300e, thereby completing the connection module 500. Hereinafter, an assembly method of a battery module in a case in which a plurality of cell cartridges 100 is stacked in a single row will be described with reference to FIGS. 1, 9, and 12.

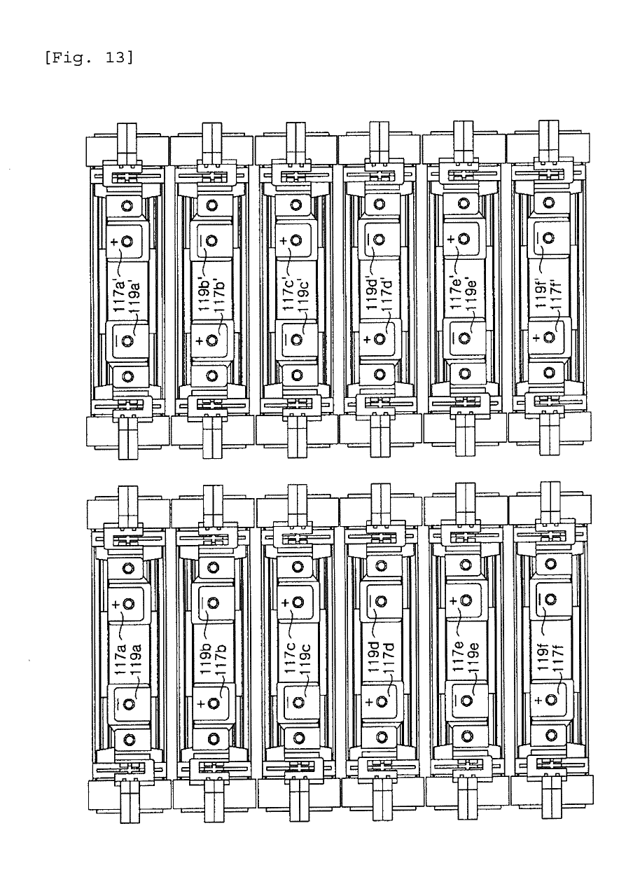

FIG. 12 is a flow chart showing an assembly method of a battery module according to another embodiment of the present invention.

Referring to FIGS. 1, 9, and 12, a plurality of cell cartridges 100 is stacked to have a single row (S1).

Subsequently, the bus bars 300a to 300e to electrically interconnect the stacked cell cartridges 110 are received in the bus bar receiving grooves 210 formed at the bus bar plate 200 (S2).

Subsequently, the bus bars 300a to 300e received in the bus bar receiving grooves 210 are covered by the plate cover 400 (S3).

The bus bars 300a to 300e, the bus bar plate 200, and the plate cover 400 are coupled as described above to form a connection module 500.

After the connection module 500 is formed, the positive electrode terminals 117a to 117f and the negative electrode terminals 119a to 119f formed at the cell cartridges 100 are inserted into the bus bar plate 200. As a result, the positive electrode terminals 117a to 117f and the negative electrode terminals 119a to 119f are automatically connected to the bus bars 300a to 300e, and therefore, the stacked cell cartridges 100 are interconnected in series (S4).

FIG. 13 is a view showing that cell cartridges according to another embodiment of the present invention are stacked, and FIG. 14 is a front view showing a bus bar plate according to another embodiment of the present invention. Hereinafter, a description of components of these embodiments identical to those of the previous embodiments will be omitted, and only the difference between these embodiments and the previous embodiments will be described.

Referring to FIGS. 1, 13, and 14, a battery module according to this embodiment is different from that according to the previous embodiment in terms of arrangement of the cell cartridges 100 and arrangement of the bus bar receiving grooves 210 formed at the bus bar plate 200.

That is, the cell cartridges are stacked in different directions so that the negative electrode terminals 119a to 119f and 119a′ to 119f′ and the positive electrode terminals 117a to 117f and 117a′ to 117f′ are alternately arranged.

Also, the bus bar receiving grooves 210 are vertically formed at the bus bar plate 200 so that the bus bars 300 can interconnect the negative electrode terminals 119a to 119f and 119a′ to 119f′ and the positive electrode terminals 117a to 117f and 117a′ to 117f′, which are alternately arranged, in series.

The first negative electrode terminal 119a is connected to the second positive electrode terminal 117b, which is vertically aligned with the first negative electrode terminal 119a, via the first bus bar 300a, and the second negative electrode terminal 119b is connected to the third positive electrode terminal 117c, which is vertically aligned with the second negative electrode terminal 119b, via the second bus bar 300b. In the same manner, the third negative electrode terminal 119c is connected to the fourth positive electrode terminal 117d, which is vertically aligned with the third negative electrode terminal 119c, via the third bus bar 300c, the fourth negative electrode terminal 119d is connected to the fifth positive electrode terminal 117e, which is vertically aligned with the fourth negative electrode terminal 119d, via the fourth bus bar 300d, and the fifth negative electrode terminal 119e is connected to the sixth positive electrode terminal 117f, which is vertically aligned with the fifth negative electrode terminal 119e, via the fifth bus bar 300e.

Also, the negative electrode terminals 119a′ to 119f′ and the positive electrode terminals 117a′ to 117f′ of the six stacked cell cartridges 100 in the neighboring row are connected to one another in series in the same manner. Specifically, the first positive electrode terminal 117a′ is connected to the second negative electrode terminal 119b′, which is vertically aligned with the first positive electrode terminal 117a′, via the first bus bar 300a′, and the second positive electrode terminal 117b′ is connected to the third negative electrode terminal 119c′, which is vertically aligned with the second positive electrode terminal 117b′, via the second bus bar 300b′. In the same manner, the third positive electrode terminal 117c′ is connected to the fourth negative electrode terminal 119d′, which is vertically aligned with the third positive electrode terminal 117c′, via the third bus bar 300c′, the fourth positive electrode terminal 117d′ is connected to the fifth negative electrode terminal 119e′, which is vertically aligned with the fourth positive electrode terminal 117d′, via the fourth bus bar 300d′, and the fifth positive electrode terminal 117e′ is connected to the sixth negative electrode terminal 119f′, which is vertically aligned with the fifth positive electrode terminal 117e′, via the fifth bus bar 300e′.

Also, the jump bar 330 horizontally interconnects the first positive electrode terminal 117a and the negative electrode terminal 119a′ of the cell cartridge 100 disposed in the row neighboring to the first positive electrode terminal 117a in series. As a result, a total of 12 cell cartridges 100 are connected to one another in series to complete a battery module.

In the battery module according to the present invention as described above, the bus bars 300 and the jump bar 330 to interconnect the cell cartridges 100 in series and/or in parallel are received in the bus bar receiving grooves 210 and the jump bar receiving groove 230 formed at the bus bar plate 200 so that the bus bars 300 and the jump bar 330 form the connection module 500 together with the bus bar plate 200 and the plate cover 400, and the cell cartridges 100 are interconnected in series and/or in parallel via the connection module 500, thereby easily achieving electrical connection between the cell cartridges 100.

Also, the bus bars 300 and the jump bar 330 are disposed in the bus bar plate 200 and the plate cover 400, which are formed of insulators. When connection work is performed, therefore, it is possible to protect workers from electrical shock, thereby improving safety.

Those skilled in the art to which the present invention pertains will appreciate that the present invention may be carried out in other specific ways than those set forth herein without departing from the technical ideas and essential characteristics of the present invention. The above embodiments are therefore to be construed in all aspects as illustrative and not restrictive. The scope of the invention should be determined by the appended claims, not by the above description, and all changes and modifications derived from the meaning and scope of the appended claims and their equivalents are intended to be embraced therein.

1. A battery module comprising:
a plurality of stacked cell cartridges to generate current;
bus bars to electrically interconnect the stacked cell cartridges;
a bus bar plate having bus bar receiving grooves, in which the bus bars are received; and
a plate cover coupled to the bus bar plate to cover the bus bars received in the bus bar receiving grooves.

2. The battery module according to claim 1, wherein
each of the cell cartridges has a positive electrode terminal and a negative electrode terminal, and
after the bus bars, the bus bar plate, and the plate cover are coupled to one another, the positive electrode terminals and the negative electrode terminals of the cell cartridges are inserted into the bus bar plate or the plate cover so that the positive electrode terminals and the negative electrode terminals are connected to the bus bars.

3. The battery module according to claim 1, wherein the bus bar plate and the plate cover are formed of insulators.

4. The battery module according to claim 1, wherein the bus bar receiving grooves are obliquely formed at the bus bar plate.

5. The battery module according to claim 1, wherein the bus bar receiving grooves are vertically formed at the bus bar plate.

6. The battery module according to claim 1, wherein the cell cartridges are stacked to have a plurality of rows,
the battery module further comprises a jump bar to electrically interconnect the cell cartridges stacked in different rows, and
the bus bar plate is further provided with a jump bar receiving groove, in which the jump bar is received.

7. The battery module according to claim 6, wherein the jump bar received in the jump bar receiving groove is covered by the plate cover together with the bus bars.

8. The battery module according to claim 7, wherein
each of the cell cartridges has a positive electrode terminal and a negative electrode terminal, and
after the bus bars, the jump bar, the bus bar plate, and the plate cover are coupled to one another, the positive electrode terminals and the negative electrode terminals of the cell cartridges are inserted into the bus bar plate or the plate cover so that the positive electrode terminals and the negative electrode terminals are connected to the bus bars and the jump bar.

9. An assembly method of a battery module comprising:
stacking a plurality of cell cartridges to generate current;
receiving bus bars to electrically interconnect the stacked cell cartridges in bus bar receiving grooves formed at a bus bar plate;
covering the bus bars received in the bus bar receiving grooves with a plate cover; and
inserting positive electrode terminals and negative electrode terminals formed at the cell cartridges into the bus bar plate or the plate cover so that the positive electrode terminals and the negative electrode terminals are connected to the bus bars.

10. An assembly method of a battery module comprising:
stacking a plurality of cell cartridges to generate current;
receiving bus bars to electrically interconnect the cell cartridges stacked in the same row in bus bar receiving grooves formed at a bus bar plate and receiving a jump bar to electrically interconnect the cell cartridges stacked in different rows in a jump bar receiving groove formed at the bus bar plate;
covering the bus bars received in the bus bar receiving grooves and the jump bar received in the jump bar receiving groove with a plate cover; and
inserting positive electrode terminals and negative electrode terminals formed at the cell cartridges into the bus bar plate or the plate cover so that the positive electrode terminals and the negative electrode terminals are connected to the bus bars and the jump bar.
